(19) United States
(12) Patent Application Publication
(10) Pub. No.: US 2021/0053338 A1
(43) Pub. Date: Feb. 25, 2021

(54) PRINTING DEVICE, PRINTING METHOD, AND OPTICAL FIBER RIBBON MANUFACTURING METHOD

(71) Applicant: FUJIKURA LTD., Tokyo (JP)

(72) Inventors: Shizuka Sekine, Chiba (JP); Kouji Tomikawa, Chiba (JP); Ken Osato, Chiba (JP); Hironori Sato, Chiba (JP)

(73) Assignee: FUJIKURA LTD., Tokyo (JP)

(21) Appl. No.: 16/960,180

(22) PCT Filed: Dec. 19, 2018
(86) PCT No.: PCT/JP2018/046751

§ 371 Date: Jul. 6, 2020

(30) Foreign Application Priority Data
Apr. 4, 2018 (JP) 2018-072357

(51) Int. Cl. B41F 9/06; B41F 17/10; B41F 31/06; B41M 1/10; G02B 6/44

(52) U.S. Cl. CPC B41F 9/063; B41F 17/10; G02B 6/4403; B41M 1/10; B41F 31/06

(57) ABSTRACT

An optical fiber ribbon manufacturing device includes: fiber-supplying units that respectively supply optical fibers; a printing device that prints a mark on each of the optical fibers; and a ribbon-forming device that manufactures an optical fiber ribbon by connecting the optical fibers on each of which the mark has been printed. The printing device includes: a supplying roller that supplies an ink; and a printing roller that includes a printing pattern on a surface thereof and that prints the mark on each of the optical fibers that are lined up in a width direction of the optical fibers by causing the ink supplied from the supplying roller to adhere to the printing pattern and transferring the ink onto the optical fibers. Projections and depressions are disposed on a surface of the supplying roller. The surface of the supplying roller opposes the printing pattern of the printing roller.

### TECHNICAL FIELD

The present invention relates to printing devices, printing methods, and optical fiber ribbon manufacturing methods.

### BACKGROUND

There are techniques wherein optical fibers constituting an optical fiber ribbon are printed (marked) with an identification mark for identifying the optical fiber ribbon. A known method for printing an identification mark on optical fibers is an ink-jet printing method (see, for example, Patent Literature 1). Unfortunately, ink-jet printing methods may not work well for high-speed printing. On the other hand, the printing method disclosed in Patent Literature 2 prints an identification mark on optical fibers at high speed by roll printing using a printing roller.

### PATENT LITERATURE

Patent Literature 1: JP 2017-134313A
Patent Literature 2: JP 2015-145128A

In cases of simultaneously printing marks, at high speed by using a printing roller, onto each of a plurality of optical fibers that are lined up in the width direction, the marks printed at the end portions of the printing roller may become faint, compared to marks printed at the central portion of the printing roller (see Table 1 further below). This may lead to deterioration in visual recognizability of the marks on the optical fiber ribbon.

### SUMMARY

One or more embodiments of the present invention print marks uniformly on respective optical fibers at the time of performing printing simultaneously with a printing roller on a plurality of optical fibers constituting an optical fiber ribbon.

According to one or more embodiments of the invention, a printing device includes: a supplying roller adapted to supply an ink; and a printing roller having a printing pattern formed on a surface thereof, the printing roller being adapted to print a mark on each of a plurality of optical fibers that are lined up in a width direction by causing the ink supplied from the supplying roller to adhere to the printing pattern and transferring the ink onto the plurality of optical fibers. Projections and depressions are formed on the supplying roller's surface that opposes the printing roller's printing pattern.

Other features of the present invention are disclosed in the following description and accompanying drawings.

The present invention can print marks uniformly on respective optical fibers at the time of performing printing simultaneously with a printing roller on a plurality of optical fibers constituting an optical fiber ribbon.

### BRIEF DESCRIPTION OF THE DRAWINGS

FIGS. 1A to 1C are diagrams illustrating an optical fiber ribbon 1. FIG. 1B is a cross-sectional view taken along line A-A of FIG. 1A. FIG. 1C is a cross-sectional view taken along line B-B of FIG. 1A.

FIG. 2 is a cross-sectional view illustrating adjacent optical fibers 2.

FIG. 3 is a diagram illustrating a manufacturing system 10 for manufacturing an optical fiber ribbon 1.

FIG. 4 is a diagram illustrating a configuration of a printing device 12.

FIG. 5 is another diagram illustrating a configuration of the printing device 12.

FIG. 6A is a diagram illustrating a mesh pattern 31 of a supplying roller 30 according to one or more embodiments. FIG. 6B is a diagram illustrating an open area rate.

FIG. 7A is a diagram illustrating a mark formed according to an example. FIG. 7B is a diagram illustrating the mark thickness.

FIG. 8 is a graph illustrating the difference between the central average value and the end average value of the mark thickness according to a first example (and a comparative example).

FIG. 9 is a graph illustrating the difference between the central average value and the end average value of the mark thickness according to a second example (and a comparative example).

FIG. 10 is a graph illustrating the difference between the central average value and the end average value of the mark thickness according to a third example.

FIG. 11 is a graph illustrating the difference between the central average value and the end average value of the mark thickness according to a fourth example.

FIGS. 12A and 12B are diagrams schematically illustrating a supplying roller 30 according to one or more embodiments.

FIGS. 13A and 13B are diagrams schematically illustrating a supplying roller 30 according to one or more embodiments.

FIG. 14 is a graph illustrating the difference between the central average value and the end average value of the mark thickness according to a fifth example and a sixth example.

### DETAILED DESCRIPTION

At least the following features are disclosed in the following description and the accompanying drawings.

Disclosed is a printing device including: a supplying roller adapted to supply an ink; and a printing roller having a printing pattern formed on a surface thereof, the printing roller being adapted to print a mark on each of a plurality of optical fibers that are lined up in a width direction by causing the ink supplied from the supplying roller to adhere to the printing pattern and transferring the ink onto the plurality of optical fibers, wherein projections and depressions are formed on the supplying roller's surface that opposes the printing roller's printing pattern. With this printing device, marks can be printed uniformly on the respective optical fibers at the time of performing printing simultaneously with the printing roller on the plurality of optical fibers constituting an optical fiber ribbon.

According to one or more embodiments, the projections and depressions are formed over an entire circumference, in a circumferential direction, of the supplying roller. In this way, the projections and depressions on the supplying roller can be made to oppose the printing roller's printing pattern, even without synchronizing the rotation of the supplying roller and the printing roller.

According to one or more embodiments, a width of the printing pattern is equal to or greater than a distance between the optical fibers located at both ends among the plurality of optical fibers lined up in the width direction; and a width of a region in which the projections and depressions are formed on the supplying roller's surface is equal to or greater than the width of the printing pattern. In this way, the projections and depressions on the supplying roller can be made to oppose the printing roller's printing pattern.

According to one or more embodiments, depressed portions and projecting portions forming the projections and depressions on the supplying roller's surface are arranged alternately along the width direction. In this way, marks can be printed uniformly on the respective optical fibers.

According to one or more embodiments, the projections and depressions are formed by forming a mesh pattern on the supplying roller's surface. In this way, a multitude of depressed portions can be arranged uniformly on the supplying roller's surface.

According to one or more embodiments, a depth of the depressed portion constituting the projections and depressions is within a range from 20 to 80 μm. In this way, marks can be printed uniformly on the respective optical fibers, even during high-speed printing.

According to one or more embodiments, the number, per inch, of the depressed portions constituting the projections and depressions is within a range from 50 to 250. In this way, marks can be printed uniformly on the respective optical fibers, even during high-speed printing.

According to one or more embodiments, an open area rate, which indicates a percentage of a total area of the depressed portions with respect to an area of the region in which the projections and depressions are formed, is within a range from 50 to 80%. In this way, marks can be printed uniformly on the respective optical fibers, even during high-speed printing.

According to one or more embodiments, a viscosity of the ink is 10 mPa·s or greater. In this way, marks can be printed uniformly on the respective optical fibers, even during high-speed printing.

According to one or more embodiments, the viscosity of the ink is less than 100 mPa·s. In this way, production of ink mists can be suppressed.

According to one or more embodiments, the ink is a UV-curable ink; and the printing device further includes a UV irradiation device. In this way, the ink can be cured promptly, and thus, high-speed printing can be performed favorably.

Also disclosed is a printing method involving: supplying an ink from a supplying roller to a printing roller having a printing pattern formed on a surface thereof; and printing a mark on each of a plurality of optical fibers that are lined up in a width direction by causing the ink supplied from the supplying roller to adhere to the printing pattern and transferring the ink onto the plurality of optical fibers, wherein projections and depressions are formed on the supplying roller's surface that opposes the printing pattern. With this printing method, marks can be printed uniformly on the respective optical fibers at the time of performing printing simultaneously with the printing roller on the plurality of optical fibers constituting an optical fiber ribbon.

Also disclosed is an optical fiber ribbon manufacturing method involving: supplying an ink from a supplying roller to a printing roller having a printing pattern formed on a surface thereof; printing a mark on each of a plurality of optical fibers that are lined up in a width direction by causing the ink supplied from the supplying roller to adhere to the printing pattern and transferring the ink onto the plurality of optical fibers; and manufacturing an optical fiber ribbon by connecting the plurality of optical fibers on each of which the mark has been printed, wherein projections and depressions are formed on the supplying roller's surface that opposes the printing pattern. With this optical fiber ribbon manufacturing method, marks can be printed uniformly on the respective optical fibers, and thus, it is possible to suppress deterioration in visual recognizability of the marks on the optical fiber ribbon.

{Optical Fiber Ribbon 1 and Mark 5}

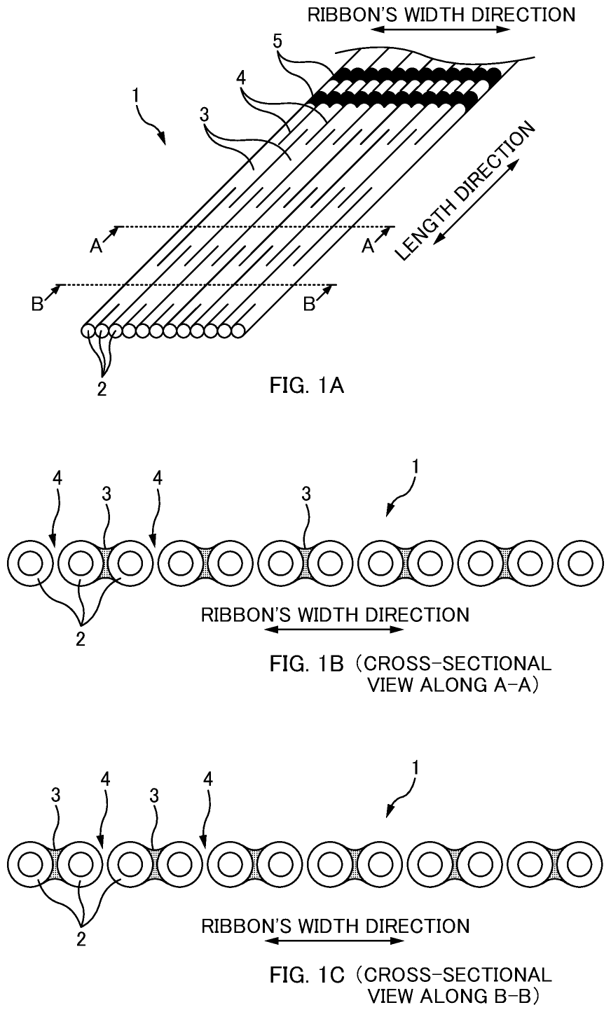

FIGS. 1A to 1C are diagrams illustrating an optical fiber ribbon 1. FIG. 1B is a cross-sectional view taken along line A-A of FIG. 1A. FIG. 1C is a cross-sectional view taken along line B-B of FIG. 1A.

In the following description, various directions are defined as follows. As illustrated in FIGS. 1A to 1C, the length direction of an optical fiber ribbon 1 is referred to simply as “length direction”. A direction parallel to optical fibers 2, which constitute the optical fiber ribbon 1, in a state where the optical fibers 2 are arranged side by side (i.e., in the state illustrated in FIG. 1A) may also be referred to as “length direction”. The direction in which the optical fibers 2 are lined up side by side in the state illustrated in FIG. 1A is referred to as “ribbon's width direction”. A direction perpendicular to the ribbon surface of the optical fiber ribbon 1 in the state illustrated in FIG. 1A is referred to as “ribbon's thickness direction”.

The optical fiber ribbon 1 according to one or more embodiments is a so-called intermittently connected (intermittently fixed) optical fiber ribbon. The intermittently connected optical fiber ribbon 1 is an optical fiber ribbon including a plurality of optical fibers 2 arranged side by side and connected intermittently. Two adjacent ones of the optical fibers 2 are connected by a connection part 3. A plurality of the connection parts 3, which connect two adjacent optical fibers 2, are arranged intermittently in the length direction. The plurality of connection parts 3 of the optical fiber ribbon 1 are arranged intermittently and two-dimensionally in the length direction and the ribbon's width direction. The connection parts 3 are formed by first applying a UV-curable resin, which serves as an adhesive (ribbon-forming material), and then irradiating and curing the resin with UV rays. Note that the connection parts 3 may be formed by a thermoplastic resin. Regions other than the connection parts 3 between the two adjacent optical fibers 2 constitute non-connected parts 4 (separated parts). In the non-connected parts 4, the two adjacent optical fibers 2 are not restrained. A non-connected part 4 is arranged adjacent to each connection part 3 in the ribbon's width direction. Thus, the optical fiber ribbon 1 can be rolled up into a cylindrical form (a bundle form), or folded up, and the multitude of optical fibers 2 can be bundled with high density.

The intermittently connected optical fiber ribbon 1 is not limited to the configuration illustrated in FIG. 1A. For example, the number of optical fibers in the optical fiber ribbon 1 may be changed, or the arrangement of the intermittently-arranged connection parts 3 may be changed. The optical fiber ribbon 1 may be a collectively-covered optical fiber ribbon in which a plurality of optical fibers 2 are covered collectively.

A mark 5 is formed on the optical fiber ribbon 1 according to one or more embodiments. The mark 5 is for identifying the optical fiber ribbon 1. The pattern of the mark 5 indicates an identification number (ribbon number). The mark 5 is formed repeatedly at predetermined intervals (e.g., at 15-cm intervals) in the length direction of the optical fiber ribbon 1. The mark 5 on the optical fiber ribbon 1 is made by arranging, side by side in the ribbon's width direction, marks 5 that are formed respectively on the optical fibers 2 according to a common pattern.

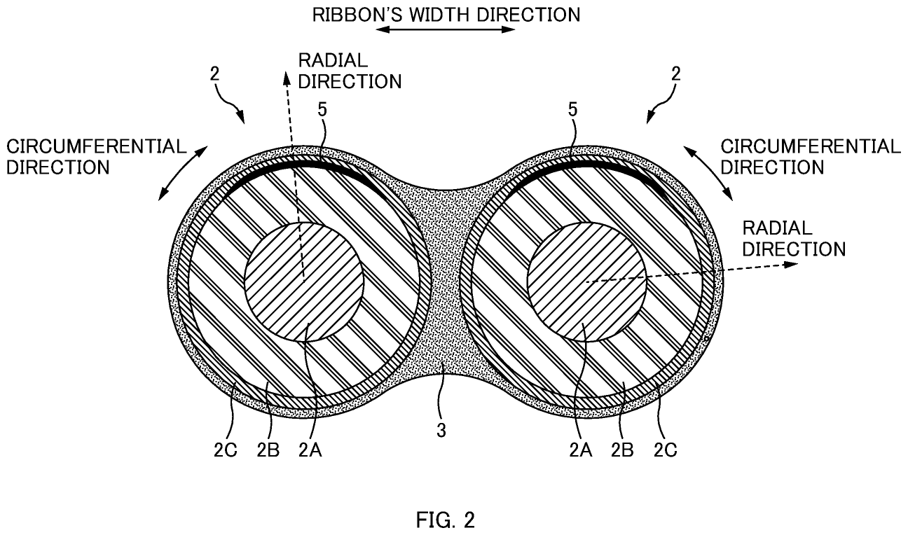

FIG. 2 is a cross-sectional view illustrating adjacent optical fibers 2.

In the following description, as illustrated in FIG. 2, the direction along a line that extends from the optical fiber 2's center toward the outer circumference in the optical fiber 2's cross section (i.e., the direction corresponding to the r-axis direction in a cylindrical coordinate system; the direction of the radius) may be referred to as “radial direction”. Further, the direction about the optical fiber 2's central axis in the optical fiber 2's cross section (i.e., the direction corresponding to the θ-axis direction in a cylindrical coordinate system) may be referred to as “circumferential direction”.

As illustrated in FIG. 2, the optical fiber 2 includes a fiber part 2A, a cover layer 2B, and a colored layer 2C. The diameter of the optical fiber 2 is, for example, about 250 μm. The fiber part 2A is constituted by a core and a cladding. The diameter (cladding diameter) of the fiber part 2A is, for example, about 125 μm. The cover layer 2B is a layer that covers the fiber part 2A. The cover layer 2B is constituted, for example, by a primary cover layer (primary coating) and a secondary cover layer (secondary coating). The diameter (outer diameter) of the cover layer 2B is, for example, about 240 μm. The colored layer 2C is a layer formed on the surface of the cover layer 2B. The colored layer 2C is formed by applying a coloring agent on the surface of the cover layer 2B. Two adjacent optical fibers 2 are connected by a ribbon-forming material constituting the connection part 3, and thereby, a ribbon-forming material layer is formed on the surface of the colored layer 2C.

Each optical fiber 2 according to one or more embodiments includes the mark 5. The mark 5 is formed between the cover layer 2B and the colored layer 2C. Thus, the mark 5 is visually observed through the colored layer 2C. Since the colored layer 2C is formed on the mark 5, the mark 5 is protected by the colored layer 2C. As described further below, the mark 5 is printed by an ink for marking. In one or more embodiments, the mark 5 is formed on a portion, in the circumferential direction, of the optical fiber 2. In the optical fiber ribbon 1 illustrated in FIG. 1A, the marks 5 on the respective optical fibers 2 are arranged at substantially the same position in the circumferential direction. However, the marks 5 on the respective optical fibers 2 may be arranged at different positions in the circumferential direction.

{Manufacturing System 10}

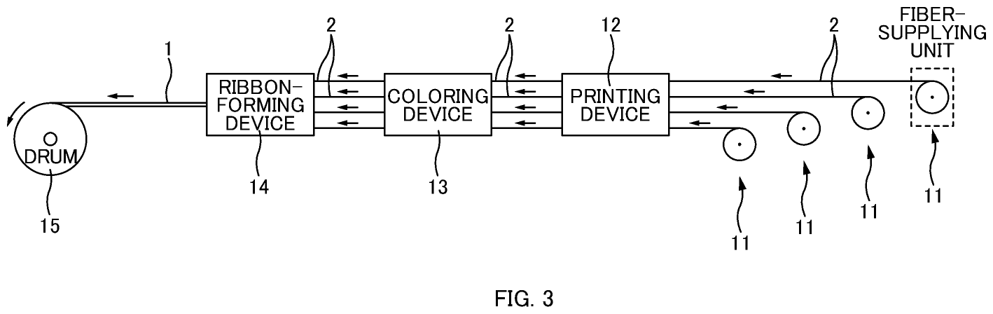

FIG. 3 is a diagram illustrating a manufacturing system for manufacturing the optical fiber ribbon 1. The manufacturing system 10 for manufacturing the optical fiber ribbon 1 includes: fiber-supplying units 11; a printing device 12; a coloring device 13; a ribbon-forming device 14; and a drum 15.

The fiber-supplying unit 11 is a supplying unit (supplying device) adapted to supply the optical fiber 2. In one or more embodiments, the fiber-supplying unit 11 supplies the optical fiber 2 before the colored layer 2C and the mark 5 are formed. Herein, the fiber-supplying unit 11 is constituted by a drum on which the optical fiber 2 (i.e., the optical fiber before formation of the colored layer 2C and the mark 5) is wound. Note, however, that the fiber-supplying unit 11 may be an optical fiber manufacturing device instead of a drum. The figure shows four fiber-supplying units 11, but in cases of manufacturing, for example, a 12-fiber optical fiber ribbon 1, the respective optical fibers 2 will be supplied respectively from twelve fiber-supplying units 11. The fiber-supplying units 11 supply the respective optical fibers 2 to the printing device 12.

The printing device 12 is a device adapted to print the mark 5 on each of the optical fibers 2. The optical fibers 2 (i.e., the optical fibers before formation of the colored layer 2C and the mark 5) are supplied to the printing device 12 from the respective fiber-supplying units 11. The printing device 12 supplies the optical fibers 2 each having the mark 5 formed thereon (i.e., the optical fibers before formation of the colored layer 2C) to the coloring device 13. The configuration of the printing device 12 will be described further below.

The coloring device 13 is a device adapted to form the colored layer 2C on the optical fibers 2. The optical fibers (i.e., the optical fibers before formation of the colored layer 2C) are supplied to the coloring device 13 from the printing device 12. The coloring device 13 colors each of the optical fibers 2 separately according to respective identification colors for identifying the respective optical fibers 2. The coloring device 13 applies coloring agents respectively to the outer circumference of the respective optical fibers 2 and cures the coloring agents, to form the colored layer 2C. For example, in cases where the coloring agent is constituted by a UV-curable coloring ink, the coloring device 13 forms the colored layer 2C by first applying the coloring agents to the respective optical fibers 2 and then irradiating the coloring agents with UV rays.

The ribbon-forming device 14 is a device adapted to form an optical fiber ribbon 1 by connecting the plurality of optical fibers 2. The optical fibers 2 (i.e., the optical fibers having the colored layer 2C and the mark 5 formed thereon) are supplied to the ribbon-forming device 14 from the coloring device 13. The ribbon-forming device 14 is a device adapted to connect the optical fibers 2 with a ribbon-forming material and thereby form an optical fiber ribbon 1. For example, the ribbon-forming device 14 forms an intermittently connected optical fiber ribbon 1 by applying a ribbon-forming material (UV-curable resin) between two adjacent optical fibers 2 and then irradiating and thereby curing the ribbon-forming material with UV rays. Alternatively, the ribbon-forming device 14 may form an intermittently connected optical fiber ribbon 1 by: first applying a ribbon-forming material to the periphery of the plurality of optical fibers 2 arranged side by side; then removing portions of the applied ribbon-forming material; and then irradiating the ribbon-forming material with UV rays. In this case, the sections between two adjacent optical fibers 2 from which the ribbon-forming material has been removed become the non-connected parts 4 (see FIG. 1), whereas the sections where the ribbon-forming material remains become the connection parts 3. Note that the ribbon-forming material is not limited to a UV-curable resin, and may be, for example, a thermoplastic resin or other adhesives.

The drum 15 is a member adapted to reel in the finished optical fiber ribbon 1. The optical fiber ribbon 1 manufactured by the ribbon-forming device 14 is supplied to the drum 15, and the optical fiber ribbon 1 is wound onto the drum 15.

{Printing Device 12}

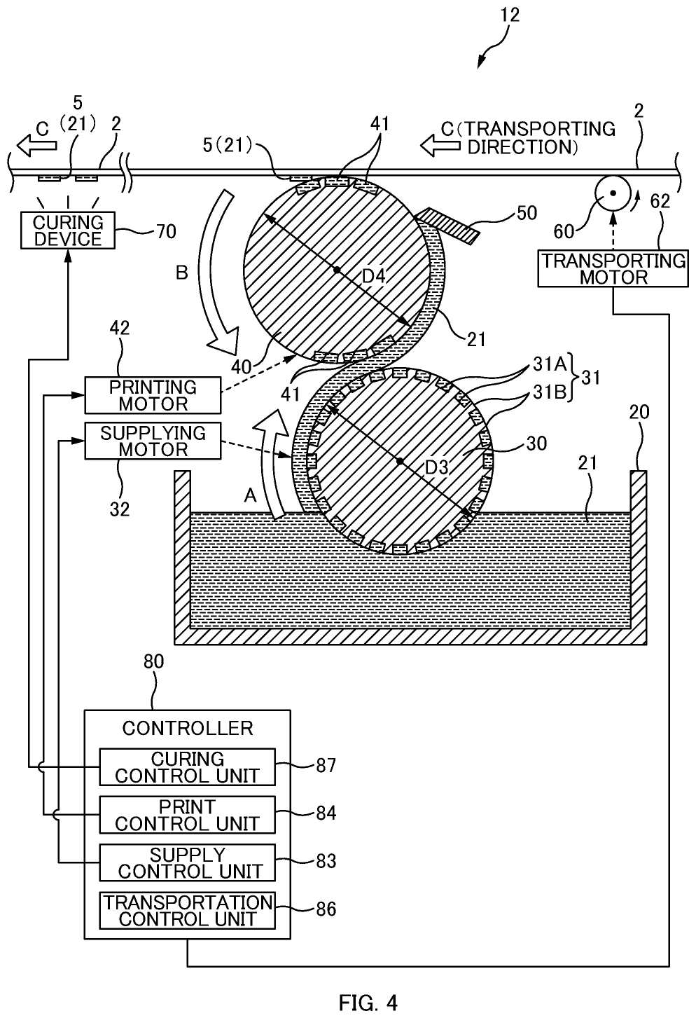

FIG. 4 is a diagram illustrating a configuration of the printing device 12. The figure illustrates a schematic configuration of the printing device 12 as viewed from the axial direction of the rotation axis of a printing roller 40. As described above, the printing device 12 is a device for printing the mark 5 on each optical fiber 2. The printing device 12 includes an ink tank 20, a supplying roller 30, a printing roller 40, and a doctor blade 50.

The ink tank 20 is a container (ink pan) for containing an ink 21 for marking. A portion of the supplying roller 30 is immersed in the ink 21 contained in the ink tank 20. In one or more embodiments, the ink 21 contained in the ink tank 20 is, for example, a UV-curable ink. Thus, the printing device 12 further includes a UV irradiation device (curing device 70) downstream of the printing roller 40 in the transporting direction. The viscosity of the ink 21 contained in the ink tank 20 may be a viscosity that enables printing on the optical fibers 2. Note, however, that, as described further below, the viscosity may be within a range from 5 to 100 mPa·s, or further within a range from 10 to 50 mPa·s.

The supplying roller 30 is a roller for supplying the ink 21 to the printing roller 40. The supplying roller 30 is also called a furnisher roller or a pick-up roller. In one or more embodiments, a portion of the supplying roller 30 is immersed in the ink 21 contained in the ink tank 20. The supplying roller 30 is rotatably supported, and is rotated by a drive force from a supplying motor 32. In one or more embodiments, the supplying roller 30 rotates in the direction of arrow A as illustrated in the figure, and thereby picks up the ink 21 in the ink tank 20 and supplies the ink 21 to the printing roller 40.

On the surface of the supplying roller 30 according to one or more embodiments, projections and depressions are formed by a mesh pattern 31. The mesh pattern 31 on the supplying roller 30 is similar to the configuration of a mesh pattern constituting a printing pattern 41 on the printing roller 40. Note, however, that the mesh pattern 31 on the supplying roller 30 is different from the mesh pattern constituting the printing pattern 41 in that the mesh pattern 31 is formed over the entire circumference (or at least in a region that opposes the printing pattern 41), in the circumferential direction, of the supplying roller 30. By forming the projections and depressions (mesh pattern 31) on the surface (outer circumferential surface) of the supplying roller 30, it is possible to print the marks 5 uniformly on the respective optical fibers 2. The reason to this is thought to be as follows: the formation of projections and depressions on the surface of the supplying roller 30 suppresses the ink 21, which fills the depressed portions 31A (described further below) in the supplying roller 30, from flowing in the width direction, and thereby the ink 21 adhering to the surface of the supplying roller 30 is suppressed from flowing in the width direction, and as a result, the ink 21 adheres to the supplying roller 30 uniformly in the width direction, thus allowing the ink 21 to be supplied uniformly in the width direction of the printing roller 40. Stated differently, in one or more embodiments, the formation of projections and depressions on the surface of the supplying roller 30 suppresses the ink 21, which has been picked up by the supplying roller 30, from gathering toward the central portion of the supplying roller 30 even when the supplying roller 30 rotates at high speed, and as a result, the ink adheres uniformly in the width direction of the printing roller 40. This will be described in further detail below.

The printing roller 40 is a roller for transferring the ink 21 to the optical fibers 2 and printing the marks 5 on the respective optical fibers 2. A printing pattern 41 for printing the mark 5 is formed on the surface of the printing roller 40. The printing pattern 41 is formed by a mesh pattern formed on the surface of the printing roller 40. The printing roller 40 is rotatably supported, and is rotated by a drive force from a printing motor 42. In one or more embodiments, the printing roller 40 rotates in the direction of arrow B as illustrated in the figure. During rotation of the printing roller 40, the ink 21 on the supplying roller 30 adheres to the surface of the printing roller 40, and the ink 21 adhering to the printing pattern 41 is transferred onto the optical fibers 2, thereby printing the mark 5 on each optical fiber 2. Stated differently, a printing plate is formed on the surface of the printing roller 40, and, by causing the ink 21 to adhere to the printing areas constituting the printing pattern 41 (i.e., filling the depressed portions (cells) in the printing plate surface with the ink 21) and transferring the ink 21 adhering to the printing areas onto the optical fibers 2, the marks 5 are printed on the respective optical fibers 2.

The printing roller 40 rotates at a rotation speed in synchronization with the linear speed (transportation speed) of the optical fibers 2. Thus, the faster the linear speed of the optical fibers 2, the faster the rotation speed of the printing roller 40. The supplying roller 30 needs to supply the ink 21 to the printing roller 40; thus, the faster the linear speed of the optical fibers 2, the faster the rotation speed of the supplying roller 30.

The doctor blade 50 is a member for scraping off excessive ink 21 adhering to the printing roller 40. Stated differently, the doctor blade 50 is a member for scraping off the ink 21 adhering to non-printing areas on the surface of the printing roller 40. On the surface of the printing roller 40 from which the ink 21 has been scraped off by the doctor blade 50, the ink 21 remains only on the printing areas (depressed portions; cells) constituting the printing pattern 41. By transferring the ink 21 adhering to the printing areas onto the optical fibers 2, the marks 5 are printed on the respective optical fibers 2.

The printing device 12 further includes a transporting mechanism 60, a curing device 70, and a controller 80.

The transporting mechanism 60 transports the optical fibers 2 in the direction of arrow C as illustrated in the figure (i.e., the transporting direction). For example, the transporting mechanism 60 is constituted by transportation rollers, and transports the optical fibers 2 by rotation caused by a drive force from a transporting motor 62. The transporting mechanism 60 also transports the optical fibers 2 supplied from the fiber-supplying units 11 (see FIG. 3), which is on the upstream side in the transporting direction, to the coloring device 13, which is on the downstream side in the transporting direction. In one or more embodiments, the transporting mechanism 60 transports the plurality of optical fibers 2 in a state arranged side by side in the width direction. The ink 21 adhering to the printing pattern 41 on the printing roller 40 is transferred onto the optical fibers 2 being transported.

The curing device 70 is adapted to cure the ink 21 transferred onto the optical fibers 2. In one or more embodiments, the ink 21 is a UV-curable ink (UV ink); thus, the curing device 70 is a UV irradiation device (UV light source). In cases where the ink 21 is a solvent ink, the curing device 70 may be constituted by a drying device (such as a heater). It should be noted that solvent ink may not work well for high-speed printing as the drying step takes a long time, whereas one or more embodiments may work well for high-speed printing because they employ a UV-curable ink for the ink 21 and the ink cures promptly by irradiation with UV rays. The non-illustrated curing device 70 (e.g., UV irradiation device) is arranged downstream of the printing roller 40 in the transporting direction (and upstream of the coloring device 13 in the transporting direction).

The controller 80 is a control unit for controlling the printing device 12. The controller 80 includes a supply control unit 83, a print control unit 84, a transportation control unit 86, and a curing control unit 87. The supply control unit 83 controls the supplying motor 32 and thereby controls the rotation of the supplying roller 30. The print control unit 84 controls the printing motor 42 and thereby controls the rotation of the printing roller 40. The transportation control unit 86 controls the transporting motor 62 and thereby controls the transportation of the optical fibers. The curing control unit 87 controls the curing device 70 to cure the ink 21 and fix the mark 5 on each optical fiber 2. For example, the controller 80 controls the linear speed of the optical fibers 2 by the transportation control unit 86, and controls the rotation speed of the supplying roller 30 by the supply control unit 83 and also controls the rotation speed of the printing roller 40 by the print control unit 84, such that the rotation speed corresponds to the linear speed of the optical fibers 2. The controller 80 also controls the UV rays to be irradiated by the curing device 70 (UV irradiation device) such that the irradiation intensity corresponds to the linear speed of the optical fibers 2.

In one or more embodiments, the controller 80 includes the supply control unit 83 and the print control unit 84, and therefore, the supplying motor 32 and the printing motor 42 can be controlled separately and individually. Thus, in one or more embodiments, the rotation speed of the supplying roller 30 and the rotation speed of the printing roller 40 can be controlled separately and individually. Note, however, that the controller 80 may control the supplying motor 32 and the printing motor 42 with a single control unit. Alternatively, both the supplying roller 30 and the printing roller 40 may be rotated by a single motor.

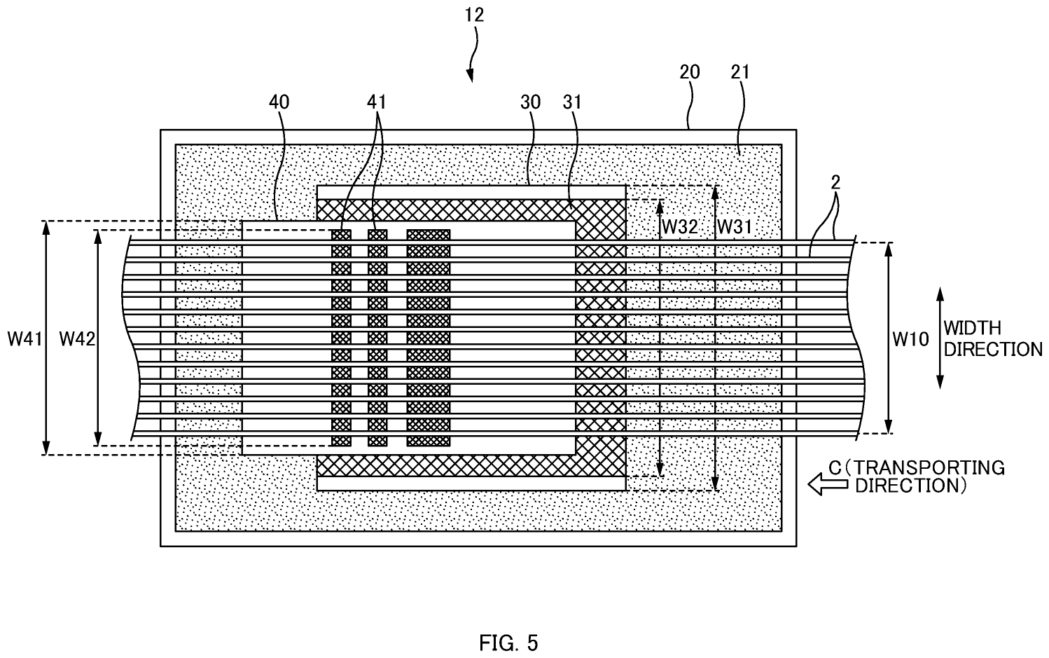

FIG. 5 is another diagram illustrating a configuration of the printing device 12. The figure illustrates a schematic configuration of the printing device 12 as viewed from a direction perpendicular to the rotation axis of a printing roller 40, i.e., from a direction perpendicular to the length direction of the optical fibers 2. Stated differently, the figure illustrates a schematic configuration of the printing device 12 as viewed from above.

In one or more embodiments, the printing roller 40 prints the marks 5 simultaneously onto the plurality of (twelve in this example) optical fibers 2. Thus, in one or more embodiments, the width W41 (i.e., the dimension in the width direction) of the printing roller 40 is equal to or greater than the distance W10 between the optical fibers 2 located at both ends (i.e., the fibers #1 and #12) among the plurality of optical fibers 2 lined up in the width direction. Further, in one or more embodiments, in order to print the marks 5 simultaneously onto the respective optical fibers 2, the printing pattern 41 formed on the surface of the printing roller 40 is formed in a rectangular shape extending in the width direction. The width W42 (i.e., the dimension in the width direction) of the printing pattern 41 is equal to or greater than the distance W10 between the optical fibers 2 located at both ends in the width direction.

In order for the supplying roller 30 to supply the ink 21 to the printing roller 40, the width W31 of the supplying roller 30 is equal to or greater than the width W41 of the printing roller 40. Further, in order for the supplying roller 30 to supply the ink 21 onto the printing pattern 41 of the printing roller 40, the width W31 of the supplying roller 30 is equal to or greater than the width W42 of the printing roller 40's printing pattern 41. Note that, since the width W41 of the printing roller 40 and the width W42 of the printing pattern 41 are equal to or greater than the distance W10 between the optical fibers 2 located at both ends (i.e., the fibers #1 and #12), the width W31 of the supplying roller 30 is also equal to or greater than the distance W10 between the optical fibers 2 located at both ends (i.e., the fibers #1 and #12).

In order to allow the supplying roller 30 to supply the ink 21 uniformly onto the printing roller 40 as described further below, the width W32 of the supplying roller 30's mesh pattern 31 (i.e., the dimension, in the width direction, of a region in which the projections and depressions are formed) is equal to or greater than the width W41 of the printing roller 40. Further, in order to allow the supplying roller 30 to supply the ink 21 uniformly onto the printing pattern 41 of the printing roller 40, the width W32 of the supplying roller 30's mesh pattern 31 (i.e., the dimension, in the width direction, of a region in which the projections and depressions are formed) is equal to or greater than the width W42 of the printing roller 40's printing pattern 41. Note that the width W32 of the supplying roller 30's mesh pattern 31 is equal to or greater than the distance W10 between the optical fibers 2 located at both ends (i.e., the fibers #1 and #12).

In the figure, for explanation's sake, the width W31 of the supplying roller 30 is wider than the width W41 of the printing roller 40. Note, however, that the width W31 of the supplying roller 30 may be the same length as the width W41 of the printing roller 40. In this case, the diameter D3 of the supplying roller 30 (see FIG. 4) and the diameter D4 of the printing roller 40 may be made the same, and the supplying roller 30 and the printing roller 40 may be made of the same material. In this way, the mesh pattern 31 on the surface of the supplying roller 30 can be formed according to the same manufacturing method as the mesh pattern constituting the printing pattern 41 of the printing roller 40.

In the figure, for explanation's sake, the width W31 of the supplying roller 30 is wider than the width W32 of the mesh pattern 31, and there are regions with no mesh pattern 31 on both edges of the supplying roller 30. Note, however, that the width W31 of the supplying roller 30 and the width W32 of the mesh pattern 31 may be made the same by forming the mesh pattern over the entire width, in the width direction, of the supplying roller 30. In this way, the width W31 of the supplying roller 30 can be reduced while ensuring the necessary width W32 of the mesh pattern 31.

In one or more embodiments, the mesh pattern 31 is formed over the entire circumference (360 degrees), in the circumferential direction, on the surface of the supplying roller 30. In this way, even if the rotation of the supplying roller 30 is not in synchronization with the rotation of the printing roller 40, the supplying roller 30's mesh pattern 31 can be made to oppose the printing roller 40's printing pattern 41 and the ink 21 can be supplied from the supplying roller 30 to the printing roller 40's printing pattern 41. As a result, the marks 5 can be printed uniformly on the respective optical fibers 2, as described further below. Thus, in cases where the controller 80 controls the rotation speed of the supplying roller 30 and the rotation speed of the printing roller 40 separately and independently, the mesh pattern 31 may be formed over the entire circumference on the surface of the supplying roller 30. Note that, in cases of controlling the rotation speed of the supplying roller 30 and the rotation speed of the printing roller 40 separately and independently, the supplying roller 30 and the printing roller 40 may not be in contact with one another. However, the supplying roller 30 and the printing roller 40 may be in contact with one another. On the other hand, in cases where the rotation of the supplying roller 30 and the rotation of the printing roller 40 are synchronized, the mesh pattern 31 may be formed only in a specific section, in the circumferential direction, of the supplying roller 30 (i.e., in a section opposing the printing roller 40's printing pattern 41).

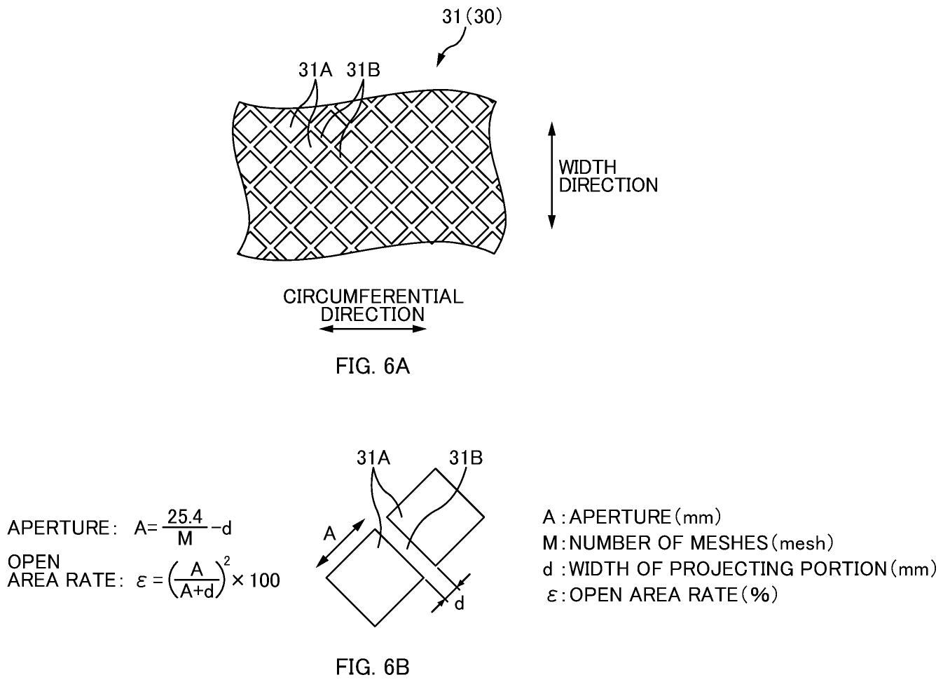

FIG. 6A is a diagram illustrating the mesh pattern 31 of the supplying roller 30 according to one or more embodiments. In the figure, the width direction is the direction parallel to the direction in which the plurality of optical fibers 2 are lined up. The circumferential direction in the figure is the direction along the outer surface of the supplying roller 30 (i.e., the direction about the central axis of the supplying roller 30).

In one or more embodiments, a multitude of square-shaped depressed portions 31A are arranged on the surface of the supplying roller 30. The depressed portions 31A of the mesh pattern 31 are recesses also referred to as meshes or cells. The depressed portions 31A are depressed recesses (ink containing portions) capable of receiving and containing ink. Netlike projecting portions 31B are formed between the depressed portions 31A, 31A. Thus, projections and depressions are formed by the depressed portions 31A and the projecting portions 31B on the surface of the supplying roller 30. By forming the mesh pattern 31 on the surface of the supplying roller 30, a multitude of depressed portions 31A can be arranged uniformly on the surface of the supplying roller 30. Methods for forming the mesh pattern 31 on the surface of the supplying roller 30 are the same as methods for forming the printing pattern 41 according to a mesh pattern on the surface of the printing roller 40.

In one or more embodiments, the projections and depressions are formed on the surface of the supplying roller 30 over the range of the width W41 of the supplying roller 30's mesh pattern 31. In this way, when the supplying roller 30 rotates, the ink 21 can be picked up uniformly in the width direction. As a result, the ink 21 can be supplied uniformly in the width direction of the printing roller 40, and also, the ink 21 can be supplied uniformly in the width direction of the printing roller 40's printing pattern 41. Thus, the marks 5 can be printed uniformly on the respective optical fibers 2.

In one or more embodiments, the depressed portions 31A and the projecting portions 31B are arranged alternately along the width direction. In this way, when the supplying roller 30 picks up the ink 21, the projecting portions 31B can stop the ink 21, which is contained in the supplying roller 30's depressed portions 31A, from flowing in the width direction, and thus, it is possible to suppress unevenness, in the width direction, in the amount of ink adhering to the surface of the supplying roller 30. In contrast, if the depressed portions 31A or the projecting portions 31B are formed so as to extend in the width direction, then, when the supplying roller 30 rotates at high speed, the ink picked up by the supplying roller 30 will tend to gather toward the central portion of the supplying roller 30 compared to that according to one or more embodiments, which will result in thinning of the thickness of the marks 5 (mark thickness) on the optical fibers 2 located at both ends (described further below).

Further, in one or more embodiments, the multitude of depressed portions 31A are arranged in a staggered fashion in a manner that the sides of each square-shaped depressed portion 31A are inclined by 45 degrees with respect to the width direction and the circumferential direction. Therefore, in one or more embodiments, the netlike (grid-like) projecting portions 31B are arranged so as to be inclined by 45 degrees with respect to the circumferential direction (and the width direction). Thus, when the supplying roller 30 picks up the ink 21, the amount of ink adhering to the surface of the supplying roller 30 can be made uniform. In contrast, if the projecting portions 31B are arranged parallel to the circumferential direction, the amount of ink adhering to the surface of the supplying roller 30 will become uneven in the width direction compared to that of one or more embodiments. However, compared to cases where the supplying roller 30 has no projections/depressions at all, provision of the projecting portions 31B, even if they are arranged parallel to the circumferential direction, can make the amount of ink adhering to the surface of the supplying roller 30 uniform in the width direction. Therefore, the orientation of the square-shaped depressed portions 31A is not limited to the orientation of the depressed portions 31A according to one or more embodiments. Further, the shape of the depressed portion 31A is not limited to the square-shape, and may be rectangular, rhombic, or parallelogram-shaped. Furthermore, the shape of the depressed portion 31A is not limited to quadrangular or polygonal, but may instead be groove-shaped, or circular or elliptic, as described further below.

As illustrated in FIG. 6B, when the width of the projecting portion 31B of the mesh pattern 31 in one or more embodiments is defined as “d” and the number of meshes is defined as “M”, the open area rate ε of the mesh pattern 31 according to one or more embodiments is calculated according to the equation shown in the figure. Note here that the unit, “mesh”, of the number of meshes M indicates the number of depressed portions 31A (meshes; cells) per inch. Therefore, the unit “mesh” corresponds to “dots per inch (dpi)”. The open area rate serves as a value indicating the area of the depressed portions 31A per unit area. Therefore, in cases where the depressed portion 31A is not square-shaped, the open area rate can be calculated as the percentage of the total area of the depressed portions 31A with respect to the area of the mesh pattern 31.

### EXAMPLES

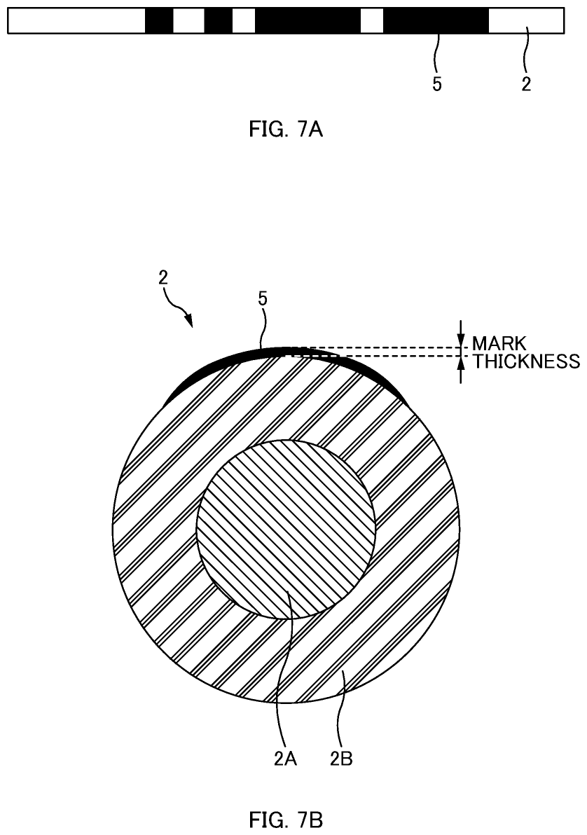

By using the printing device 12 illustrated in FIGS. 4 and 5, a mark 5 as illustrated in FIG. 7A was printed simultaneously with the printing roller 40 on each of twelve optical fibers 2 arranged side by side in the width direction. The twelve optical fibers 2 were arranged parallel to one another with 4-mm intervals therebetween. The printing speed (i.e., the linear speed of the optical fibers 2) was within a range from 100 to 1500 m/min. The diameter D3 of the supplying roller 30 and the diameter D4 of the printing roller 40 were 15 cm. For the ink for printing the marks 5, a UV-curable resin having a viscosity of 50 mPa·s was used.

Two optical fibers 2 printed in the central area of the printing roller 40 (i.e., the fibers #6 and #7) and the optical fibers 2 located at both ends (i.e., the fibers #1 and #12) were the measurement targets, and the mark thickness of each of the measurement-target optical fibers 2 was measured. Herein, “mark thickness” refers to the thickness of the mark 5 in the radial direction, as illustrated in FIG. 7B. The following values were calculated: the average value of mark thicknesses measured at five points on each of the two optical fibers 2 (i.e., the fibers #6 and #7) printed in the central area of the printing roller 40 (i.e., the average value of mark thicknesses at a total of ten points; referred to hereinafter as “central average value”); the average value of mark thicknesses measured at five points on each of the two optical fibers 2 (i.e., the fibers #1 and #12) located at both ends (i.e., the average value of mark thicknesses at a total of ten points; referred to hereinafter as “end average value”); and the difference between the two average values (i.e., the value found by subtracting the end average value from the central average value).

### Comparative Example: Relationship Between Printing Speed and Mark Thickness

As a comparative example, a supplying roller having no mesh pattern 31 was used instead of the supplying roller 30 according to one or more embodiments, and the marks 5 were printed simultaneously with the printing roller 40 respectively on twelve optical fibers 2 arranged side by side in the width direction. The measurement results for the comparative example are shown in the table below.

TABLE 1
Comparative example: No mesh pattern

Mark thickness (μm)

| Printing speed | Central | End | |
|---|---|---|---|
| (m/min) | average value | average value | Difference |
| 100 | 8.7 | 8.2 | 0.5 |
| 300 | 10.2 | 8.1 | 2.1 |
| 500 | 9.5 | 6.0 | 3.5 |
| 800 | 9.3 | 4.7 | 4.6 |
| 1000 | 11.3 | 4.8 | 6.5 |
| 1500 | 10.1 | 1.9 | 8.2 |

As can be understood from the “central average value” of the comparative example, the mark thickness of the optical fibers 2 printed in the central area of the printing roller 40 is stable at around 10 μm, even when the printing speed is fast. In contrast, as can be understood from the “end average value” of the comparative example, the mark thickness of the optical fibers 2 located at both ends becomes thinner as the printing speed becomes faster. As a result, the difference between the mark thickness of the central optical fibers 2 and the mark thickness of the optical fibers 2 located at both ends becomes larger as the printing speed becomes faster. This means that the marks 5 on the optical fibers 2 printed at the end portions of the printing roller 40 become fainter as the printing speed becomes faster. If an optical fiber ribbon 1 is manufactured by connecting such optical fibers 2, a difference in darkness will occur among the marks 5 in the width direction of the optical fiber ribbon 1, which will result in deterioration in visual recognizability of the marks 5 on the optical fiber ribbon 1. Stated differently, in cases where a supplying roller having no mesh pattern 31, as in the comparative example, is used to simultaneously print the marks 5 at high speed with the printing roller 40 onto the respective optical fibers 2 arranged side by side in the width direction, the visual recognizability of the marks 5 on the optical fiber ribbon 1 will deteriorate.

The reason why the mark thickness of the optical fibers 2 located at both ends becomes thin when the printing speed is increased, as in the comparative example, is thought to be because the ink picked up by the supplying roller gathers toward the central portion of the supplying roller as a result of high-speed rotation of the supplying roller, and thus, a difference arises in the ink adhesion amount between the central portion and the end portions of the printing roller 40.

### First Example: Relationship Between Printing Speed and Mark Thickness, and Relationship Between Mesh Depth and Mark Thickness

In the first example, a supplying roller 30 having a mesh pattern 31 formed on the entire circumference thereof was used, and marks 5 were printed simultaneously with a printing roller 40 respectively on twelve optical fibers 2 arranged side by side in the width direction. In the first example, the number of meshes of the supplying roller 30's mesh pattern 31 was 150 mesh.

In the first example, the mesh depth (the depth of each depressed portion 31A) of the supplying roller 30's mesh pattern 31 was within a range from 10 to 100 μm. More specifically, the mesh depth was set to 10 μm, 20 μm, 40 μm, 80 μm, and 100 μm. As in the comparative example, the mark thickness was measured by setting the printing speed (i.e., the linear speed of the optical fibers 2) within a range from 100 to 1500 m/min.

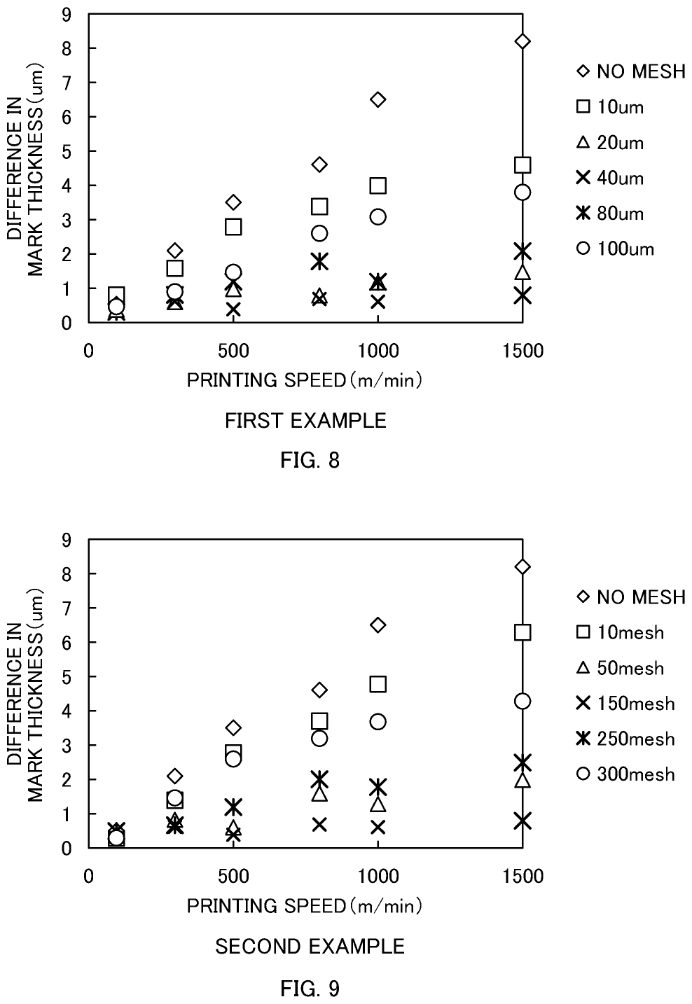

FIG. 8 is a graph illustrating the difference between the central average value and the end average value of the mark thickness according to the first example (and the comparative example). The horizontal axis of the graph indicates the printing speed (m/min). The vertical axis of the graph indicates the value (difference) found by subtracting the end average value from the central average value. In the first example, the central average value was within a range from 8.2 to 12.4 μm.

As can be understood from the graph of the first example, the difference in mark thickness can be suppressed in the first example compared to the comparative example, even when the printing speed is fast. The reason why this effect can be achieved is thought to be as follows: the formation of projections and depressions, which are constituted by the mesh pattern 31, on the surface of the supplying roller 30 suppresses the ink 21, which fills the depressed portions 31A in the supplying roller 30, from flowing in the width direction, and thereby the ink 21 adhering to the surface of the supplying roller 30 is suppressed from flowing in the width direction, and as a result, the ink 21 adheres to the supplying roller 30 uniformly in the width direction, thus allowing the ink 21 to be supplied uniformly in the width direction of the printing roller 40. Stated differently, it is thought that the formation of projections and depressions, which are constituted by the mesh pattern 31, on the surface of the supplying roller 30 suppresses the ink, which has been picked up by the supplying roller 30, from gathering toward the central portion of the supplying roller 30 even when the supplying roller 30 rotates at high speed, and as a result, the ink adheres uniformly in the width direction of the printing roller 40.

Further, as can be understood from the graph of the first example, when the mesh depth (the depth of each depressed portion 31A) is from 20 to 80 μm, the mark thickness is relatively uniform. It is thought that, when the mesh depth was 10 μm, the effect of forming the mesh pattern 31 on the supplying roller 30 was diminished because the mesh depth was too shallow. On the other hand, it is thought that, when the mesh depth was 100 μm, the too-deep mesh depth diminished the action of surface tension of the ink having entered the meshes (cells), and as a result, the ink picked up by the supplying roller 30 gathered toward the central portion of the supplying roller 30 when the supplying roller 30 rotated at high speed. Thus, the mesh depth (the depth of the depressed portions 31A) of the mesh pattern 31 on the supplying roller 30 may be within a range from 20 to 80 μm.

### Second Example: Relationship Between Number of Meshes and Mark Thickness

Also in the second example, a supplying roller 30 having a mesh pattern 31 formed on the entire circumference thereof was used, and marks 5 were printed simultaneously with a printing roller 40 respectively on twelve optical fibers 2 arranged side by side in the width direction. In the second example, the mesh depth (the depth of each depressed portion 31A) of the supplying roller 30's mesh pattern 31 was 40 μm.

In the second example, the number of meshes (i.e., the number of depressed portions 31A per inch) of the supplying roller 30's mesh pattern 31 was within a range from 10 to 300 mesh (i.e., from 10 to 300 dpi). More specifically, the number of meshes was set to 10, 50, 150, 250, and 300 mesh. As in the comparative example and the first example, the mark thickness was measured by setting the printing speed (i.e., the linear speed of the optical fibers 2) within a range from 100 to 1500 m/min.

FIG. 9 is a graph illustrating the difference between the central average value and the end average value of the mark thickness according to the second example (and the comparative example). The horizontal axis of the graph indicates the printing speed (m/min). The vertical axis of the graph indicates the value (difference) found by subtracting the end average value from the central average value. In the second example, the central average value was within a range from 8.3 to 11.9 μm.

As can be understood from the graph of the second example, the difference in mark thickness can be suppressed also in the second example compared to the comparative example, even when the printing speed is fast. The reason why this effect can be achieved is thought to be as follows: the ink 21, which fills the depressed portions 31A in the supplying roller 30, is suppressed from flowing in the width direction, and thereby the ink 21 adhering to the surface of the supplying roller 30 is suppressed from flowing in the width direction, and as a result, the ink 21 adheres to the supplying roller 30 uniformly in the width direction, thus allowing the ink 21 to be supplied uniformly in the width direction of the printing roller 40. Stated differently, it is thought that the formation of projections and depressions, which are constituted by the mesh pattern 31, on the surface of the supplying roller 30 suppresses the ink, which has been picked up by the supplying roller 30, from gathering toward the central portion of the supplying roller 30 even when the supplying roller 30 rotates at high speed, and as a result, the ink adheres uniformly in the width direction of the printing roller 40.

Further, as can be understood from the graph of the second example, when the number of meshes is from 50 to 250 mesh (from 50 to 250 dpi), the mark thickness is relatively uniform. It is thought that, when the number of meshes was 10 mesh (10 dpi), the projections and depressions on the surface of the supplying roller 30 were too coarse, and when the number of meshes was 300 mesh (300 dpi), the projections and depressions on the surface of the supplying roller 30 were too fine, and thus, the effect of forming the mesh pattern 31 on the supplying roller 30 was diminished. Thus, the number of meshes of the mesh pattern 31 on the supplying roller 30 may be within a range from 50 to 250 mesh (from 50 to 250 dpi).

### Third Example: Relationship Between Open Area Rate and Mark Thickness

Also in the third example, a supplying roller 30 having a mesh pattern 31 formed on the entire circumference thereof was used, and marks 5 were printed simultaneously with a printing roller 40 respectively on twelve optical fibers 2 arranged side by side in the width direction. In the third example, the number of meshes (i.e., the number of depressed portions 31A per inch) of the supplying roller 30's mesh pattern 31 was set to 50 mesh or 250 mesh. Further, in the third example, the printing speed was set to 1500 m/min (high-speed setting). In the third example, the open area rate (see FIG. 6B) of the supplying roller 30's mesh pattern 31 was set within a range from 10 to 90%.

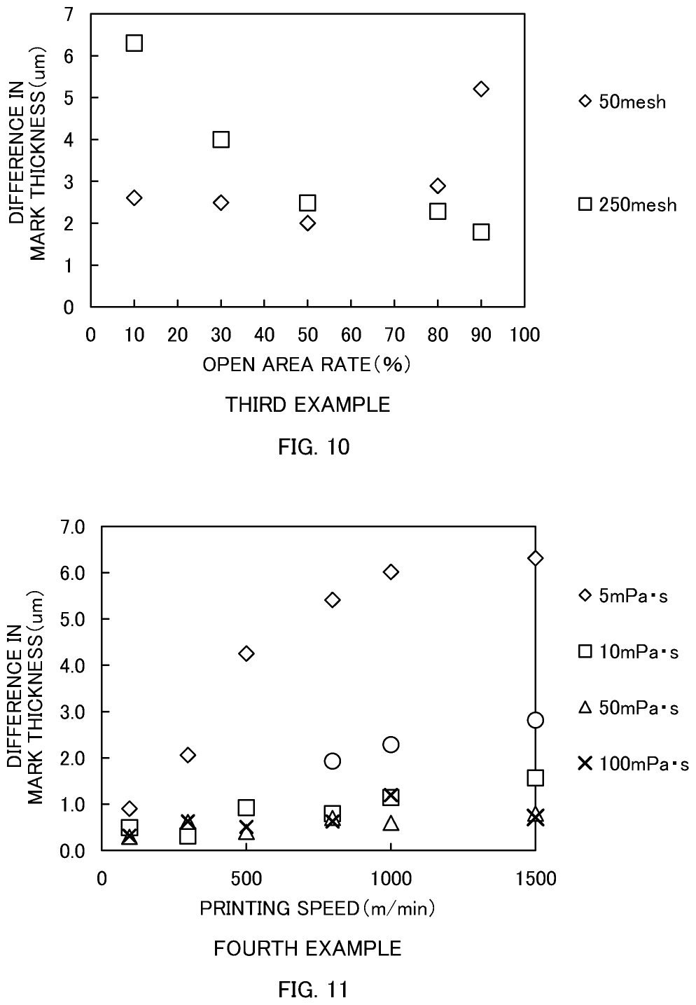

FIG. 10 is a graph illustrating the difference between the central average value and the end average value of the mark thickness according to the third example. The horizontal axis of the graph indicates the open area rate (%). The vertical axis of the graph indicates the value (difference) found by subtracting the end average value from the central average value. In the second example, the central average value was within a range from 8.7 to 10.1 μm at 50 mesh, and from 8.9 to 10.7 μm at 250 mesh.

As can be understood from the graph of the third example, when the number of meshes was 50 mesh, the difference between the central average value and the end average value of the mark thickness increased at an open area rate of 90%. When the number of meshes was 250 mesh, the difference between the central average value and the end average value of the mark thickness increased when the open area rate was 30% or lower. Thus, the open area rate of the mesh pattern 31 on the supplying roller 30 may be within a range from 50 to 80%. Note that 50 mesh and 250 mesh are the upper and lower limit values of the number of meshes (see the second example); thus, it is thought that, when the open area rate of the supplying roller 30's mesh pattern 31 is within a range from 50 to 80%, the difference between the central average value and the end average value of the mark thickness can be suppressed similarly in a range where the number of meshes of the supplying roller 30's mesh pattern 31 is from 50 to 250 mesh.

### Fourth Example: Relationship Between Viscosity and Mark Thickness

Also in the fourth example, a supplying roller 30 having a mesh pattern 31 formed on the entire circumference thereof was used, and marks 5 were printed simultaneously with a printing roller 40 respectively on twelve optical fibers 2 arranged side by side in the width direction. In the fourth example, the number of meshes of the supplying roller 30's mesh pattern 31 was 150 mesh. Further, in the fourth example, the mesh depth of the supplying roller 30's mesh pattern 31 was 40 μm.

In the fourth example, the viscosity of the ink was within a range from 5 to 100 mPa·s. More specifically, the viscosity of the ink was set to 5, 10, 50, and 100 mPa·s. The mark thickness was measured by setting the printing speed (i.e., the linear speed of the optical fibers 2) within a range from 100 to 1500 m/min.

FIG. 11 is a graph illustrating the difference between the central average value and the end average value of the mark thickness according to the fourth example. The horizontal axis of the graph indicates the printing speed (m/min). The vertical axis of the graph indicates the value (difference) found by subtracting the end average value from the central average value. In the fourth example, the central average value was within a range from 8.3 to 11.8 μm.

As can be understood from the graph of the first example, in cases where the viscosity of the ink was 5 mPa·s, the mark thickness of the optical fibers 2 located at both ends became thin when the printing speed became fast, as in the comparative example. In contrast, when the viscosity of the ink was 10 mPa·s or greater, it was possible to suppress differences in mark thickness, even when the printing speed was fast. Thus, the viscosity of the ink may be 10 mPa·s or greater.

It should be noted that, when the viscosity of the ink was 100 mPa·s, a large amount of ink mist was produced. This is thought to be because, when the viscosity of the ink was 100 mPa·s, a large amount of ink was picked up by the supplying roller 30, and a large amount of ink adhered to the printing roller 40. Thus, the viscosity of the ink may be less than 100 mPa·s. Stated differently, the viscosity of the ink may be within a range from 10 to 50 mPa·s.

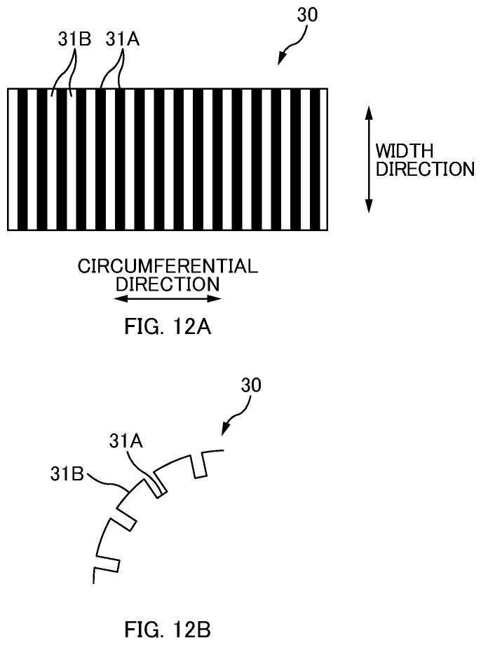

FIGS. 12A and 12B are diagrams schematically illustrating a supplying roller 30 according to one or more embodiments. Note that the printing device 12 according to one or more embodiments has the same configuration as the printing device 12 according to the above-described embodiments, except for the supplying roller 30.

On the surface of the supplying roller 30 according to one or more embodiments, groove-shaped depressed portions 31A extending along the width direction are arranged over the entire circumference in the circumferential direction with predetermined intervals therebetween. Ridge-shaped projecting portions 31B extending along the width direction are formed between the groove-shaped depressed portions 31A, 31A. Thus, on the surface of the supplying roller 30 according to one or more embodiments, the projecting portions 31B extending along the width direction are arranged over the entire circumference in the circumferential direction with predetermined intervals therebetween. Thus, on the surface of the supplying roller, projections and depressions are formed by the depressed portions 31A and the projecting portions 31B. Also in one or more embodiments, the formation of projections and depressions on the surface of the supplying roller 30 allows the marks 5 to be printed uniformly on the respective optical fibers 2. The reason to this is thought to be as follows: the formation of projections and depressions on the surface of the supplying roller 30 suppresses the ink 21, which fills the depressed portions 31A in the supplying roller 30, from flowing between the projecting portions 31B, 31B in the width direction due to the influence of viscosity, and thereby the ink 21 adhering to the surface of the supplying roller 30 is suppressed from flowing in the width direction, and as a result, the ink 21 adheres to the supplying roller 30 uniformly in the width direction, thus allowing the ink 21 to be supplied uniformly in the width direction of the printing roller 40. Thus, also in one or more embodiments, the formation of projections and depressions on the surface of the supplying roller 30 suppresses the ink 21, which has been picked up by the supplying roller 30, from gathering toward the central portion of the supplying roller 30 even when the supplying roller 30 rotates at high speed, and as a result, the ink adheres uniformly in the width direction of the printing roller 40. This will be described in further detail below.

Also in one or more embodiments, the width of the groove-shaped depressed portions 31A (i.e., the width of the region in which the depression pattern is formed) is at least equal to or greater than the width W42 of the printing pattern 41, as with the aforementioned width W32 of the mesh pattern 31. The groove-shaped depressed portions 31A may be formed over the entire width of the supplying roller 30. Note, however, that there may be regions without the depressed portions 31A on both edges, in the width direction, of the supplying roller 30.

In one or more embodiments, the groove-shaped depressed portions 31A are formed along the width direction. Thus, when the supplying roller 30 picks up the ink, the amount of ink adhering to the surface of the supplying roller 30 can be made uniform. In contrast, if the groove-shaped depressed portions 31A are formed along the circumferential direction, the amount of ink adhering to the surface of the supplying roller 30 will become uneven in the width direction compared to that according to one or more embodiments. However, compared to cases where the supplying roller 30 has no projections/depressions at all, provision of the groove-shaped depressed portions 31A, even if they are formed along the circumferential direction, can make the amount of ink adhering to the surface of the supplying roller 30 uniform in the width direction. Therefore, the orientation of the groove-shaped depressed portions 31A is not limited to the width direction.

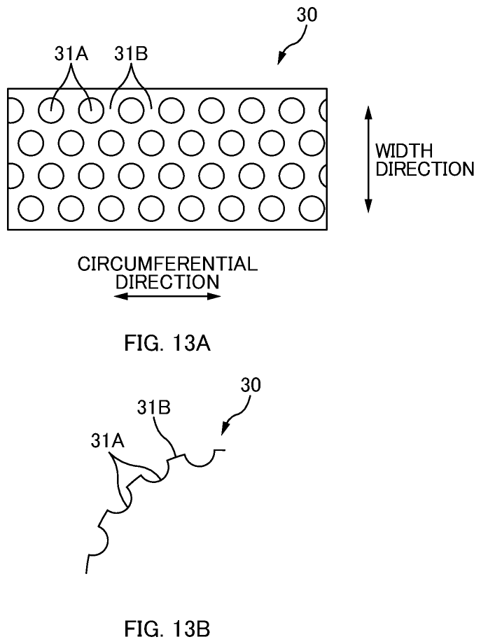

FIGS. 13A and 13B are diagrams schematically illustrating a supplying roller 30 according to one or more embodiments. Note that the printing device 12 according to one or more embodiments has the same configuration as the printing device 12 according to the above-described embodiments, except for the supplying roller 30.

On the surface of the supplying roller 30 according to one or more embodiments, a multitude of circular depressed portions 31A are arranged. Projecting portions 31B are formed between the circular depressed portions 31A, 31A. Thus, on the surface of the supplying roller, projections and depressions are formed by the depressed portions and the projecting portions. Also in one or more embodiments, the formation of projections and depressions (the mesh pattern 31) on the surface of the supplying roller 30 allows the marks 5 to be printed uniformly on the respective optical fibers 2. This will be described in further detail below.

Also in one or more embodiments, the width of the region in which the multitude of depressed portions 31A are formed (i.e., the region in which the depression pattern is formed) is at least equal to or greater than the width W42 of the printing pattern 41, as with the aforementioned width W32 of the mesh pattern 31. The depressed portions 31A may be formed over the entire width of the supplying roller 30. Note, however, that there may be regions without the depressed portions 31A on both edges, in the width direction, of the supplying roller 30.

### Examples

By using the respective printing devices 12 according to one or more embodiments, marks 5 were printed simultaneously with the printing roller 40 respectively on twelve optical fibers 2 arranged side by side in the width direction. The twelve optical fibers 2 were arranged parallel to one another with 4-mm intervals therebetween. As in the examples of one or more embodiments, the printing speed (i.e., the linear speed of the optical fibers 2) was within a range from 100 to 1500 m/min. The diameter D3 of the supplying roller 30 and the diameter D4 of the printing roller 40 were 15 cm. For the ink for printing the marks 5, a UV-curable resin having a viscosity of 50 mPa·s was used.

In the fifth example, the width (i.e., the dimension in the circumferential direction) of each depressed portion 31A in the printing roller 40 according to one or more embodiments was 500 μm, and the depth of each depressed portion 31A was 30 μm. The pitch of the depressed portions 31A (i.e., the interval between the depressed portions 31A, 31A; the dimension of each projecting portion 31B in the circumferential direction) was 500 μm.

In the sixth example, a multitude of depressed portions 31A were arranged in a staggered fashion on the surface of the printing roller 40 according to one or more embodiments in lines inclined by 45 degrees with respect to the width direction and the circumferential direction. The diameter of each circular depressed portion 31A was 200 μm, and the depth of each depressed portion 31A was 50 μm. The pitch of the depressed portions 31A (i.e., the interval between the depressed portions 31A, 31A) was 300 μm.

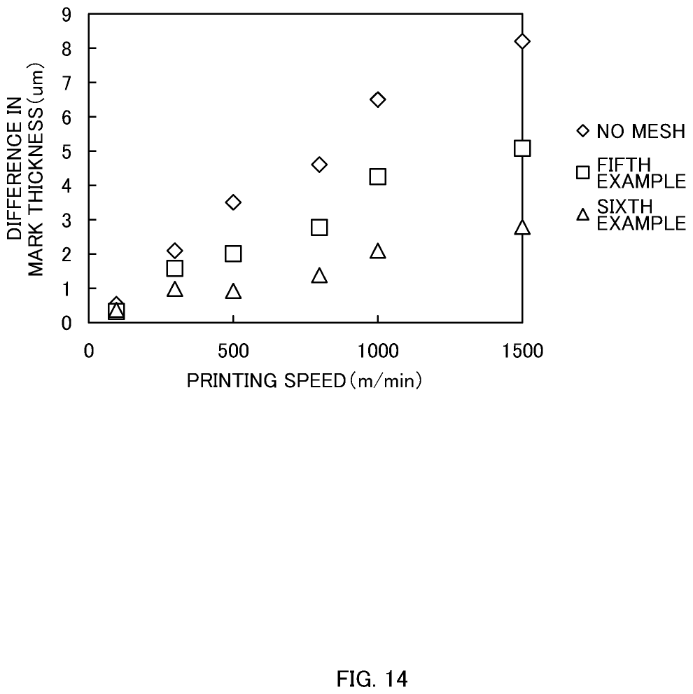

FIG. 14 is a graph illustrating the difference between the central average value and the end average value of the mark thickness according to the fifth example and the sixth example. The horizontal axis of the graph indicates the printing speed (m/min). The vertical axis of the graph indicates the value (difference) found by subtracting the end average value from the central average value. In the fifth example, the central average value was within a range from 8.0 to 11.1 μm. In the sixth example, the central average value was within a range from 8.7 to 11.2 μm.

As can be understood from the graph of the fifth example, the difference in mark thickness can be suppressed in the fifth example compared to the comparative example, even when the printing speed is fast. The reason why this effect can be achieved is thought to be as follows: due to the influence of the ink's viscosity, the ink 21, which fills the depressed portions 31A in the supplying roller 30, is suppressed from flowing in the width direction between the projecting portions 31B, 31B, and thereby the ink 21 adhering to the surface of the supplying roller 30 is suppressed from flowing in the width direction, and as a result, the ink 21 adheres to the supplying roller 30 uniformly in the width direction, thus allowing the ink 21 to be supplied uniformly in the width direction of the printing roller 40. Stated differently, it is thought that the formation of projections and depressions, which are constituted by the groove-shaped depressed portions 31A, on the surface of the supplying roller 30 suppresses the ink, which has been picked up by the supplying roller 30, from gathering toward the central portion of the supplying roller 30 even when the supplying roller 30 rotates at high speed, and as a result, the ink adheres uniformly in the width direction of the printing roller 40.

Further, as can be understood from the graph of the sixth example, the difference in mark thickness can be suppressed in the sixth example compared to the comparative example, even when the printing speed is fast. The reason why this effect can be achieved is thought to be as follows: the ink 21, which fills the depressed portions 31A in the supplying roller 30, is suppressed from flowing in the width direction, and thereby the ink 21 adhering to the surface of the supplying roller 30 is suppressed from flowing in the width direction, and as a result, the ink 21 adheres to the supplying roller 30 uniformly in the width direction, thus allowing the ink 21 to be supplied uniformly in the width direction of the printing roller 40. Stated differently, it is thought that the formation of projections and depressions, which are constituted by the circular depressed portions 31A, on the surface of the supplying roller 30 suppresses the ink, which has been picked up by the supplying roller 30, from gathering toward the central portion of the supplying roller 30 even when the supplying roller 30 rotates at high speed, and as a result, the ink adheres uniformly in the width direction of the printing roller 40.

Note that the sixth example is more capable of suppressing the difference in mark thickness compared to the fifth example even when the printing speed becomes fast. The reason why this effect can be achieved is thought to be as follows: in the sixth example, since the depressed portions 31A and the projecting portions 31B are arranged alternately in the width direction, the projecting portions 31B can stop the ink 21, which is contained in the supplying roller 30's depressed portions 31A, from flowing in the width direction, and thus, the ink, which has been picked up by the supplying roller 30, is suppressed from gathering toward the central portion of the supplying roller 30. Therefore, the depressed portions 31A and the projecting portions 31B may be arranged alternately in the width direction on the surface of the supplying roller 30, as in the above-described embodiments.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1: Optical fiber ribbon; 2: Optical fiber; 2A: Fiber part; 2B: Cover layer; 2C: Colored layer; 3: Connection part; 4: Non-connected part; 5: Mark; 10: Ribbon manufacturing system; 11: Fiber-supplying unit; 12: Printing device; 13: Coloring device; 14: Ribbon-forming device; 15: Drum; 20: Ink tank; 21: Ink; 30: Supplying roller; 31: Mesh pattern; 31A: Depressed portion; 31B: Projecting portion; 32: Supplying motor; 40: Printing roller; 41: Printing pattern; 42: Printing motor; 50: Doctor blade; 60: Transporting device; 62: Transporting motor; 70: Curing device; 80: Controller; 83: Supply control unit; 84: Print control unit; 86: Transportation control unit; 87: Curing control unit.

1.-13. (canceled)

14. An optical fiber ribbon manufacturing device comprising:
fiber-supplying units that respectively supply optical fibers;
a printing device that prints a mark on each of the optical fibers; and
a ribbon-forming device that manufactures an optical fiber ribbon by connecting the optical fibers on each of which the mark has been printed, wherein
the printing device comprises:
a supplying roller that supplies an ink; and
a printing roller that comprises a printing pattern on a surface thereof and that prints the mark on each of the optical fibers that are lined up in a width direction of the optical fibers by causing the ink supplied from the supplying roller to adhere to the printing pattern and transferring the ink onto the optical fibers,
projections and depressions are disposed on a surface of the supplying roller, and
the surface of the supplying roller opposes the printing pattern of the printing roller.

15. The optical fiber ribbon manufacturing device according to claim 14, wherein the projections and depressions are disposed over an entire circumference of the supplying roller in a circumferential direction.

16. The optical fiber ribbon manufacturing device according to claim 14, wherein
a width of the printing pattern is equal to or greater than a distance between optical fibers at both ends among the optical fibers lined up in the width direction, and
a width of a region in which the projections and depressions are disposed on the surface of the supplying roller is equal to or greater than the width of the printing pattern.

17. The optical fiber ribbon manufacturing device according to claim 14, wherein depressed portions and projecting portions that form the projections and depressions on the surface of the supplying roller are disposed alternately along the width direction.

18. The optical fiber ribbon manufacturing device according to claim 17, wherein the projections and depressions are formed by a mesh pattern on the surface of the supplying roller.

19. The optical fiber ribbon manufacturing device according to claim 14, wherein a depth of a depressed portion constituting the projections and depressions is within a range from 20 to 80 μm.

20. The optical fiber ribbon manufacturing device according to claim 14, wherein a number of depressed portions constituting the projections and depressions is within a range from 50 to 250 per inch.

21. The optical fiber ribbon manufacturing device according to claim 14, wherein an open area rate that indicates a percentage of a total area of depressed portions with respect to an area of a region in which the projections and depressions are disposed is within a range from 50 to 80%.

22. The optical fiber ribbon manufacturing device according to claim 14, wherein a viscosity of the ink is 10 mPa·s or greater.

23. The optical fiber ribbon manufacturing device according to claim 22, wherein the viscosity of the ink is less than 100 mPa·s.

24. The optical fiber ribbon manufacturing device according to claim 22, wherein the viscosity of the ink is within a range from 10 to 50 mPa·s.

25. The optical fiber ribbon manufacturing device according to claim 14, wherein
the ink is a UV-curable ink, and
the optical fiber ribbon manufacturing device further comprises a UV irradiation device.

26. An optical fiber ribbon manufacturing method comprising:
supplying optical fibers;
supplying an ink from a supplying roller to a printing roller that comprises a printing pattern on a surface thereof;
printing a mark on each of the optical fibers that are lined up in a width direction of the optical fibers by causing the ink supplied from the supplying roller to adhere to the printing pattern and transferring the ink onto the optical fibers; and
manufacturing an optical fiber ribbon by connecting the optical fibers on each of which the mark has been printed, wherein
projections and depressions are disposed on a surface of the supplying roller, and
the surface of the supplying roller opposes the printing pattern.

27. The optical fiber ribbon manufacturing method according to claim 26, wherein a viscosity of the ink is within a range from 10 to 50 mPa·s.
